(19) United States
(12) Patent Application Publication
(10) Pub. No.: US 2001/0039700 A1
(43) Pub. Date: Nov. 15, 2001

(54) FABRIC AND A PROCESS AND APPARATUS FOR MAKING THE FABRIC

(76) Inventor: RONALD G. KRUEGER, NEW BRAUNFELS, TX (US)

Correspondence Address: OWENS CORNING, 2790 COLUMBUS ROAD, GRANVILLE, OH, 43023, US

(21) Appl. No.: 09/067,667

(22) Filed: Apr. 28, 1998

(51) Int. Cl. D04H 1/06; B29D 28/00

(52) U.S. Cl. 28/103; 156/174; 156/178; 264/103; 264/172.19

(57) ABSTRACT

A method and apparatus are provided for making a fabric from one or more reinforcing fibers. The apparatus comprises a non-planar form about which the one or more reinforcing fibers are wrapped. The apparatus further includes conveying apparatus, fiber dispensing apparatus, drive apparatus, and separating apparatus. The conveying apparatus includes at least one conveyor element traveling along the form and also about which the fibers are wrapped for moving the wrapped fibers along the form. The drive apparatus is coupled to the conveying apparatus for effecting movement of the at least one conveyor element. The fiber dispensing apparatus supports one or more fiber sources such that the one or more fiber sources are movable with the dispensing apparatus around the form thereby allowing the fibers from the one or more fiber sources to be wrapped about the form and the at least one conveyor element as the dispensing apparatus moves around the form. The separating apparatus is positioned at a separating station for separating the fabric from the one or more conveyor elements. A fabric formed by the method and apparatus is also disclosed.

### CROSS REFERENCE TO RELATED APPLICATION

This application is related to contemporaneously filed U.S. patent application Ser. No. ______, entitled [symbol] APPARATUS AND METHOD FOR SPREADING FIBROUS TOWS INTO LINEAR ARRAYS OF GENERALLY UNIFORM DENSITY AND PRODUCTS MADE THEREBY, [symbol] by Ronald G. Krueger, having attorney docket No. 24452A, the disclosure of which is hereby incorporated by reference.

### TECHNICAL FIELD

This invention is directed to a fabric and a process and apparatus for making the fabric.

### BACKGROUND OF THE INVENTION

Processes and apparatuses are known for making reinforcement fabrics from reinforcing materials such as glass or carbon fibers. Such fabrics are commonly used in composite products, such as printed circuit boards, skis, rail car tanks, boat hulls, honeycomb reinforcements and the like. Typically, such fabrics are formed via a knitting or weaving operation. However, knitting and weaving operations are quite complex and throughput rates are low. Hence, while such knitting and weaving processes may be effective, they are time consuming and inefficient and, thus, expensive.

Accordingly, there is a need in the art for a more efficient and more cost effective process for making composite product reinforcement fabrics.

### SUMMARY OF THE INVENTION

This need is met by the present invention whereby improved processes and apparatuses are provided for forming reinforcing fabrics for use in composite products. The processes and apparatuses of the present invention are simpler and faster and, hence, more cost effective, than prior art processes and apparatuses used heretofore. The fabric formed in accordance with the present invention may be used in the manufacture of composite products via molding, pultrusion, filament winding or like processes. It may also be used in the manufacture of honeycomb reinforcements or supports.

In accordance with a first aspect of the present invention, an apparatus is provided for making a fabric from one or more fibers. The apparatus comprises a generally cylindrical form about which one or more fibers are wrapped. The apparatus further includes conveying apparatus, fiber dispensing apparatus, drive apparatus and separating apparatus. The conveying apparatus includes at least one conveyor element traveling along the form and also about which the fibers are wrapped for moving the wrapped fibers along the form. The fiber dispensing apparatus is movable about the form. The drive apparatus is coupled to the conveying apparatus and the fiber dispensing apparatus for effecting movement of the at least one conveyor element and the fiber dispensing apparatus. The fiber dispensing apparatus supports one or more fiber sources such that the one or more fiber sources are movable with the dispensing apparatus around the form thereby allowing the one or more fibers from the one or more fiber sources to be wrapped about the form and the at least one conveyor element as the dispensing apparatus moves around the form. The separating apparatus is positioned at a separating station for separating the fabric from one or both of the form and the at least one conveyor element. The form may end before the separating station such that the fabric need only be separated from the at least one conveyor element.

The form may comprise a circular cylinder having an inner passage.

The at least one conveyor element preferably comprises two or more conveyor elements, such as first and second endless belts.

The conveying apparatus may further comprise drive rollers coupled to the drive apparatus and a plurality of idler rollers which together along with inner and outer sections of the cylinder define paths about which the endless belts travel.

In accordance with one embodiment of the present invention, the first and second endless belts extend through the inner passage of the cylinder.

A combining station may be positioned in proximity of the form. Portions of the fibers are joined to one another at the combining station to form the fabric. The combining station may include a radiant heater, a convection oven or an ultra-violet radiation source.

The fiber dispensing apparatus may comprise one or more carousels rotatably mounted to a fixed structure. The one or more carousels include a plurality of dispensing stations for supporting a plurality of fiber sources.

The drive apparatus may comprise a single drive motor coupled to the conveying apparatus and the fiber dispensing apparatus. Alternatively, the drive apparatus may comprise a first drive motor coupled to the conveying apparatus for effecting movement of the at least one conveyor element and a second drive motor coupled to the fiber dispensing apparatus for effecting movement of the fiber dispensing apparatus.

In accordance with a second aspect of the present invention, an apparatus is provided for making a fabric from a plurality of fibers. The apparatus comprises a generally hollow form about which a plurality of fibers are wrapped. It further comprises conveying apparatus, fiber dispensing apparatus, drive apparatus and separating apparatus. The conveying apparatus includes at least one conveyor element traveling along the form and also about which the fibers are wrapped for moving the wrapped fibers along the form. The fiber dispensing apparatus is movable about the form. The drive apparatus is coupled to the conveying apparatus for effecting movement of the at least one conveyor element. The fiber dispensing apparatus supports a plurality of fiber sources such that the fiber sources are movable with the dispensing apparatus around the form thereby allowing the fibers from the fiber sources to be wrapped about the form and the at least one conveyor element as the dispensing apparatus moves around the form. The separating apparatus is positioned at the separating station for cutting the fabric.

The hollow form may comprise a circular cylinder having an inner passage.

In accordance with a third aspect of the present invention, a method is provided for forming a fabric from one or more fibers comprising the steps of: providing one or more fibers; providing a non-planar form and at least one conveyor element which is adapted to move along the form; wrapping the one or more fibers about the form and the at least one conveyor element to form a fabric; moving the at least one conveyor element along the form such that the wrapped fibers are moved along the form; and separating the fabric from one or both of the at least one conveyor element and the form.

The step of wrapping one or more fibers about the form and the at least one conveyor element comprises the steps of: providing a fiber dispensing apparatus movable around the form for supporting the one or more fibers such that the fibers are movable with the dispensing apparatus; and moving the fiber dispensing apparatus around the form such that the fibers are wrapped about the form and the at least one conveyor element.

The step of providing a non-planar form may comprise the step of providing a circular cylinder having an inner passage.

The one or more fibers may comprise a plurality of fibers in strand form, one or more fibers of composite material, or one or more ribbons of reinforcing fibers.

The step of providing one or more fibers may comprise the step of providing one or more fibers selected from the group consisting of S-glass fibers, E-glass fibers, graphite fibers, aramid fibers, polyimide fibers, cotton fibers, polyester fibers, and ceramic fibers, such as silicon carbide and alumina fibers.

In accordance with a fourth aspect of the present invention, a process is provided for forming a carbon fiber fabric comprising the steps of: providing one or more carbon fibers; wrapping the one or more carbon fibers about a non-planar form; and joining portions of the one or more fibers to one another.

The step of providing one or more carbon fibers comprises the step of providing first and second ribbons of carbon material each including a plurality of carbon fibers which are joined to one another via a polymeric material.

The wrapping step comprises the steps of: wrapping the first ribbon about the form such that portions of the first ribbon form with an axis extending across the form an angle of from about 1° to about 89.9°; and wrapping the second ribbon about the first ribbon such that portions of the second ribbon form with the axis an angle of from about −1° to about −89.9°.

The joining operation preferably takes place without a weaving or knitting operation being performed.

In accordance with a fifth aspect of the present invention, a fabric is provided. The fabric comprises one or more spread fiber tows wherein first portions of the one or more tows are angularly positioned relative to second portions of the one or more tows and are joined to the first portions.

Each of the one or more spread fiber tows preferably comprises a plurality of fibers spread from a first areal density to a second, lighter areal density. The term [symbol] areal density [symbol] is used herein to describe the weight/cross sectional area of a tow or combined tows.

Each of the one or more spread fiber tows may comprise one or more ribbons or strands having a plurality of spread fibers. The ribbons or strands may further include polymeric material for maintaining the fibers in a spread condition.

The fibers may be selected from the group consisting of S-glass fibers, E-glass fibers, graphite fibers, aramid fibers, polyimide fibers, cotton fibers, polyester fibers, silicon carbide fibers and the like.

Preferably, the first tow portions form with a first horizontal axis an angle of from about 1.0 degree to about 89.9 degrees and the second tow portions form with a second horizontal axis parallel to the first horizontal axis an angle of from about −1 degree to about −89.9 degrees.

In accordance with a sixth embodiment of the present invention, a method is provided for forming a fabric. The method comprises the steps of: providing one or more spread tows; wrapping the one or more tows about a form; and joining first portions of the one or more tows to second portions of the one or more tows.

The wrapping step preferably comprises the step of wrapping the one or more tows about a non-planar form such as a cylindrical form.

The step of providing one or more spread tows may comprise the step of providing one or more ribbons formed from one or more spread tows.

The objectives, features, and advantages of the present invention will become apparent upon consideration of the detailed description and the appended drawings.

### BRIEF DESCRIPTION OF DRAWINGS

FIG. 1 is a perspective view of an apparatus constructed in accordance with a first embodiment of the present invention;

FIG. 1A is a side view of a portion of the apparatus of FIG. 1;

FIG. 2 is a perspective view of the first carousel of the apparatus of FIG. 1;

FIG. 2A is a cross sectional view of the cylindrical form of the apparatus of FIG. 1;

FIG. 3 is a perspective view of a carousel constructed in accordance with a second embodiment of the present invention;

FIG. 4 is a perspective view of a carousel constructed in accordance with a third embodiment of the present invention;

FIG. 5 is a perspective view of the apparatus of FIG. 1 showing a side opposite the one illustrated in FIG. 1 and with the combining station, the separating station, the cooling station, the ribbon sources and a portion of the frame removed;

FIG. 6 is a perspective view of the separating station and a portion of the form of the apparatus of FIG. 1;

FIG. 7 is a perspective view of a portion of the apparatus of FIG. 1 illustrating the drive and idler rollers of the conveying apparatus and the drive apparatus;

FIG. 7A is a cross sectional view of the drive and idler rollers shown in FIG. 7;

FIG. 8 is a plan view of the radiant heater at the combining station of the apparatus of FIG. 1 with the heater in its open position;

FIG. 9 is a view of the bottom of the cylindrical form with the first and second conveyor belts broken away to show first and second guide rollers mounted to the bottom of the form; and

FIG. 10 is a view, partially broken away, of a fabric formed in accordance with the present invention.

### DETAILED DESCRIPTION AND PREFERRED EMBODIMENTS OF THE INVENTION

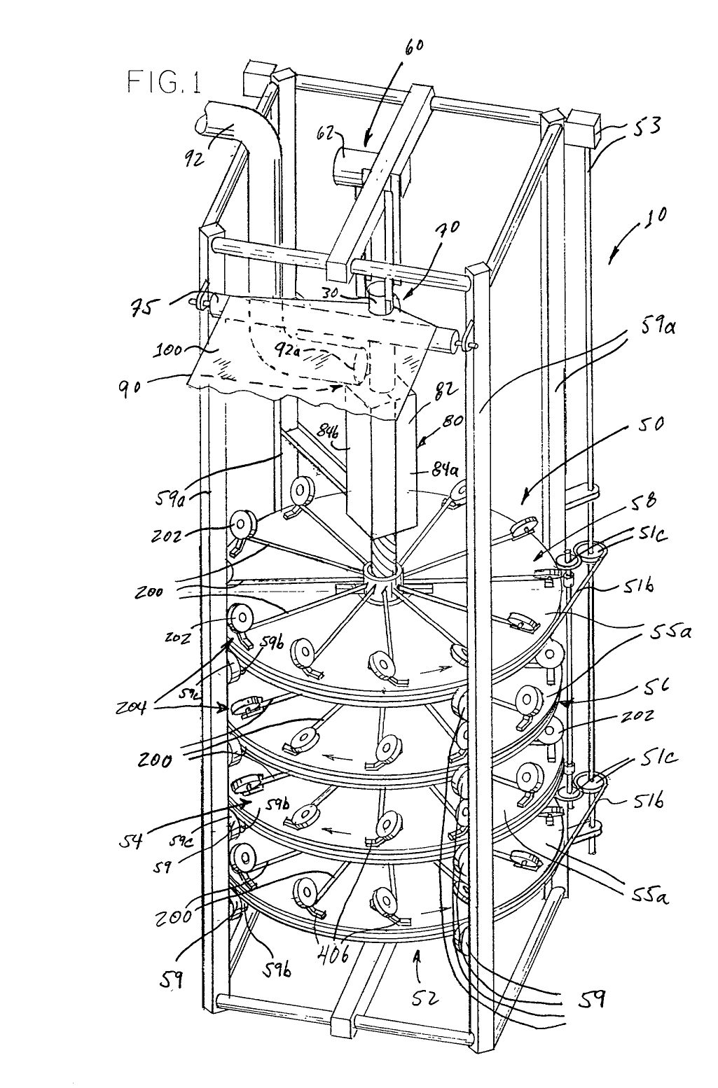

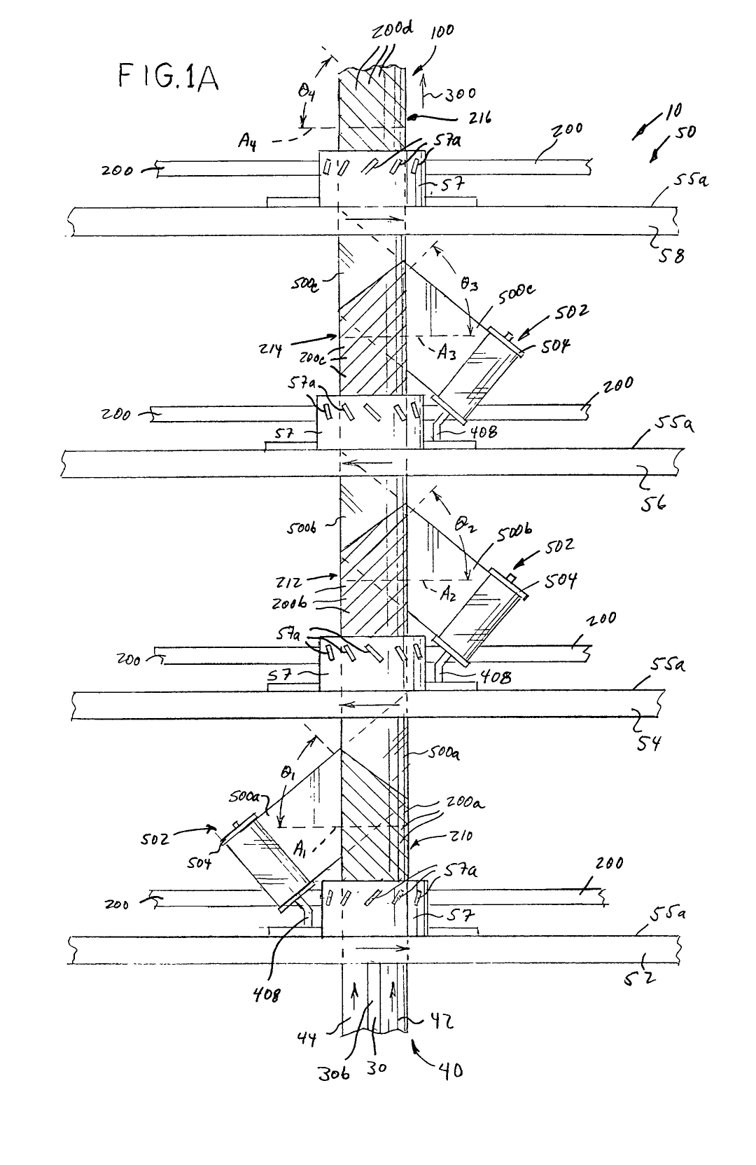

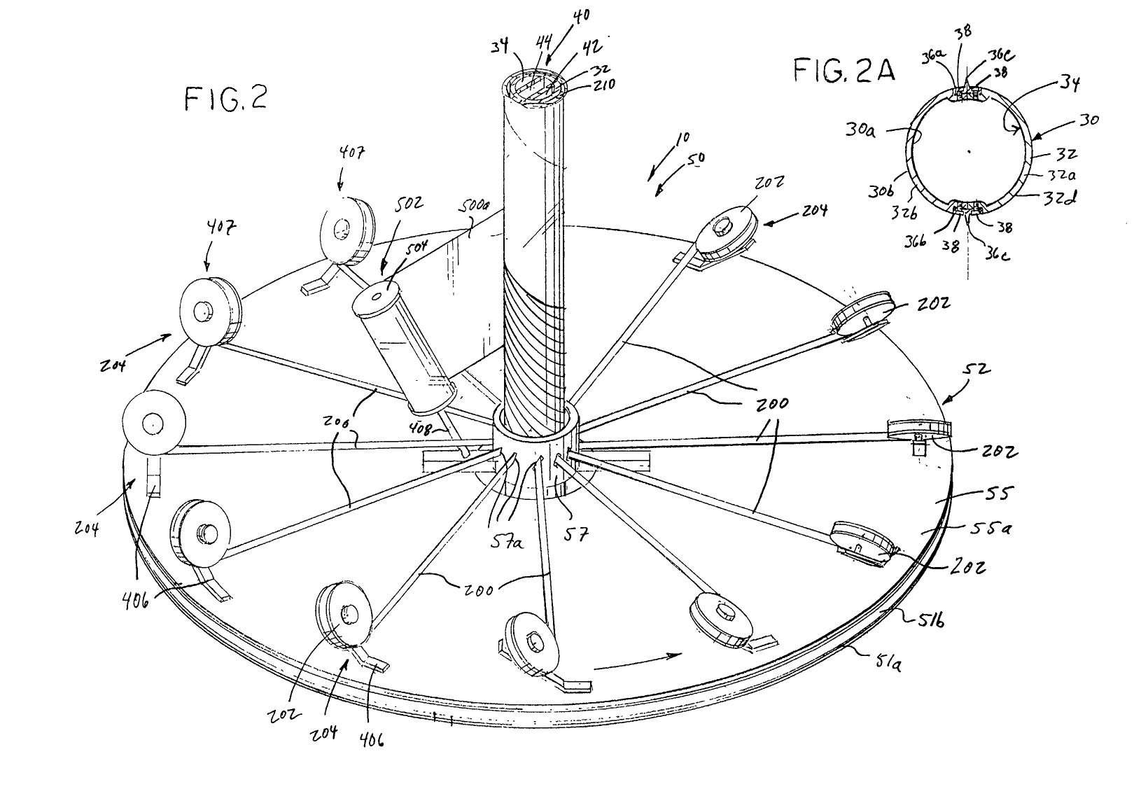

An apparatus 10 constructed in accordance with a first embodiment of the present invention for forming a fabric from one or more fibers is shown in FIGS. 1, 1A and 2. The term [symbol] fiber [symbol] is used herein to describe a single filament. As will be discussed further below, two or more fibers may be combined to form a strand, ribbon, tow or other fiber element. Preferably, the fibers are reinforcing fibers such that a reinforcement fabric 100 is formed, see FIG. 10. The reinforcement fabric 100 may be used in the manufacture of fiber reinforced composite products such as honeycomb reinforcements (not shown).

The apparatus 10 comprises a form or mandrel 30 about which one or more of the fibers are wrapped. The apparatus 10 also includes conveying apparatus 40, fiber dispensing apparatus 50, drive apparatus 60 and separating apparatus 70.

In the embodiment illustrated in FIGS. 1 and 2, a plurality of ribbons 200, each comprising a plurality of the fibers, are provided. Each ribbon 200 is wound about a spool 202 such that the spool 202 and the wound ribbon 200 comprise a fiber or ribbon source 204. The fibers of each ribbon 200 are held together via a polymeric material which may comprise a conventional thermoplastic or thermosetting material. The fibers preferably comprise continuous reinforcing fibers such as glass fibers (e.g., S-glass or E-glass), natural fibers (e.g., cotton fibers) or other synthetic fibers. The other synthetic fibers may comprise fibers formed from materials such as aramid, carbon or graphite, a metallic or ceramic material, a polymeric material such as a polyester, and other non-glass man-made materials, or combinations thereof, having suitable reinforcing characteristics. It is also contemplated that the fibers may comprise non-reinforcing fibers formed, for example, from a polymeric material such as polyimide. Other materials from which the fibers may be formed are set out in PCT Application WO92/08095, published May 14, 1992, entitled [symbol] THREE DIMENSIONAL FIBER STRUCTURES HAVING IMPROVED PENETRATION RESISTANCE, [symbol] the disclosure of which is incorporated herein by reference. Each ribbon 200 may comprise, for example, 50 or more fibers.

A process and apparatus for forming ribbons or strands from spread tows is set out in the above-incorporated U.S. patent application entitled [symbol] APPARATUS AND METHOD FOR SPREADING FIBROUS TOWS INTO LINEAR ARRAYS OF GENERALLY UNIFORM DENSITY AND PRODUCTS MADE THEREBY. [symbol] This application teaches passing a tow of fibers through a fiber spreader and spreading the tow from a first areal density to a second, lighter areal density. The term [symbol] areal density [symbol] is used herein to describe the weight/cross sectional area for a tow. Cross sectional area=height×width, where the area is generally transverse the length (the longest dimension) of the tow. Preferably, the spread fibers are maintained in their spread condition via a polymeric material or an adhesively coated substrate as described in the incorporated U.S. patent application. Each ribbon 200 may comprise a spread tow having for example from about 50 fibers to about 100,000 fibers or more.

In the illustrated embodiment, the form 30 comprises a circular cylinder 32 having an inner passage 34, see FIGS. 2 and 2A. The cylinder 32 comprises first and second curved sections 32a and 32b which are joined together by first and second plates 36a and 36b and bolts 38. Each plate 36a and 36b includes a longitudinally extending ridge 36c on its outer surface. A ring (not shown) may be coupled to a bottom section of the cylinder 32 via arms (not shown) such that it is spaced from an outer surface 32d of the cylinder 32. An inner surface of the ring and the outer surface 32d of the cylinder 32 define a passageway which, as will be discussed below, receives first and second endless belts 42 and 44. The arms on the ring extend out from the inner surface of the ring toward the outer surface 32d of the cylinder 32. As will also be discussed below, the ridges 36c on the plates 36a and 36b and the arms on the ring function as guides for the belts 42 and 44. The curved sections 32a and 32b, plates 36a and 36b and ring may be formed from any conventional rigid material including metals (e.g., steel or aluminum) and composites (e.g., a glass reinforced plastic). The cylinder 32 may have a wall thickness of from about 0.0625 inch to about 2.0 inches or larger and an inner diameter of from about 3 inches to about 100 inches or larger. It is also contemplated that the form 30 may be solid and/or have another geometric shape such as an elliptical, rectangular, or triangular shape.

As shown in FIG. 9, a plurality of first and second guide rollers 45a and 45b are rotatably coupled to a bottom end 32e of the cylinder 32. Each roller 45a and 45b includes at least one recessed portion 45c.

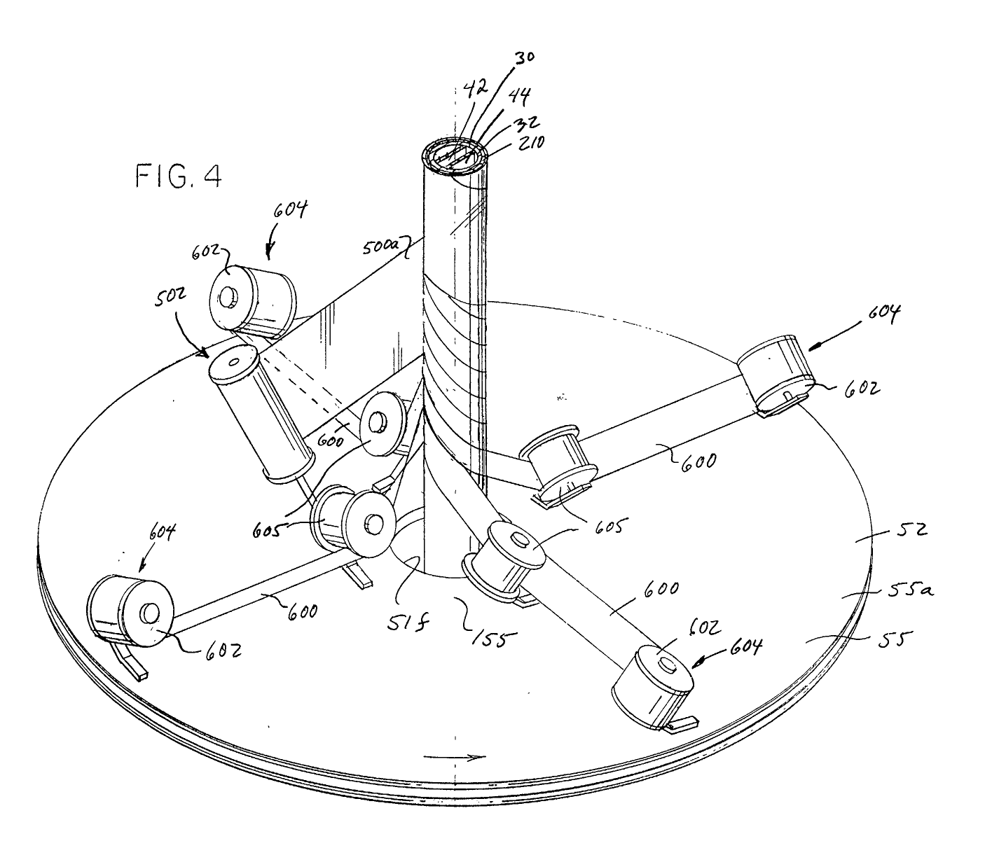

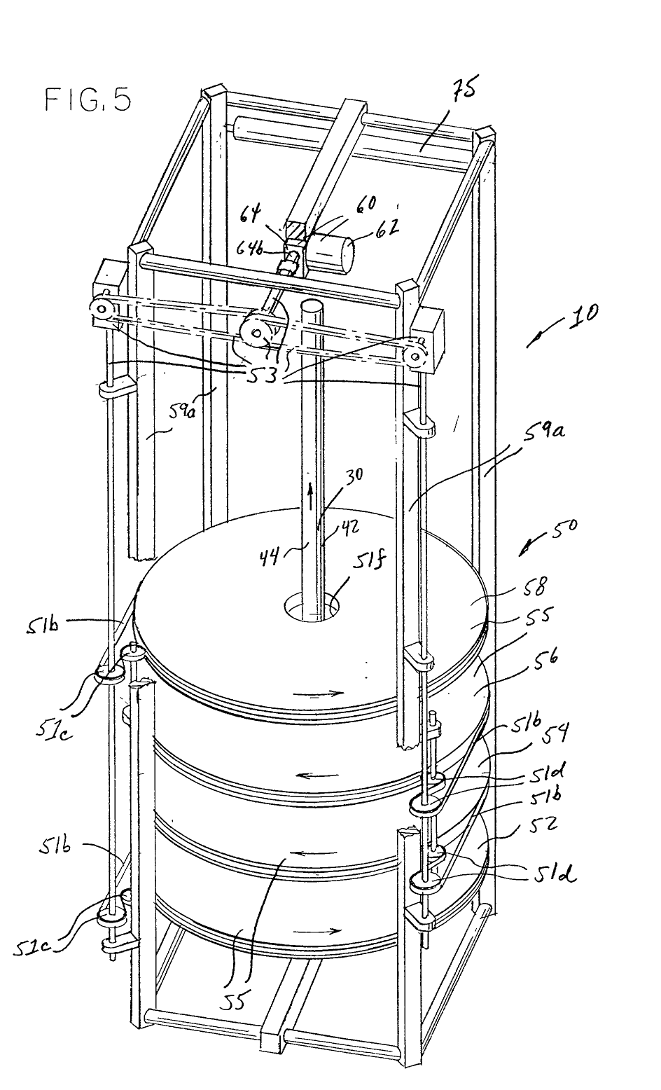

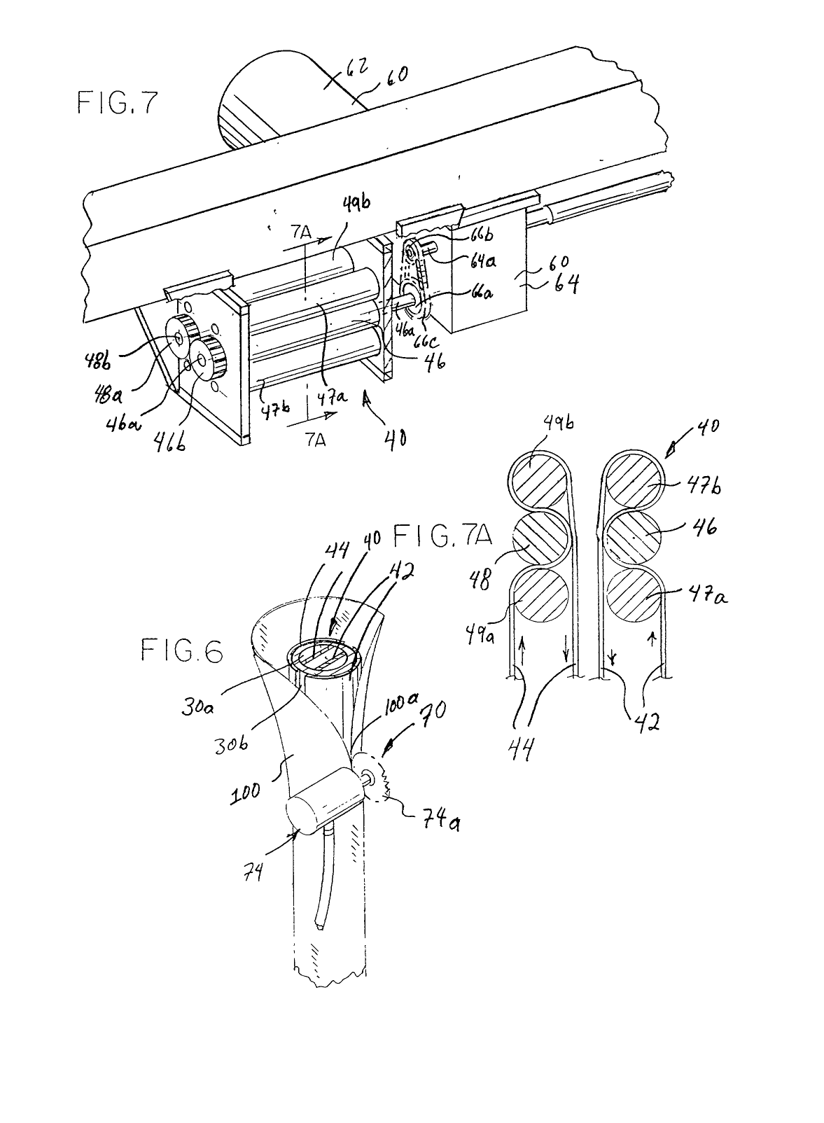

The conveying apparatus 40 includes the first and second endless belts 42 and 44. Each belt 42 and 44 is wrapped about the form 30 such that it extends along inner and outer longitudinal portions 30a and 30b of the form 30, see FIGS. 2A and 6. The belts 42 and 44 extend through the passageway defined by the inner ring surface and the outer cylinder surface 32d. The longitudinally extending ridges 36c on the first and second plates 36a and 36b, see FIG. 2A, guide the belts 42 and 44 as they move upwardly along the outer portion 30b of the form 30 and prevent the belts 42 and 44 from overlapping as they move up the form 30. The arms on the ring ensure that the belts 42 and 44 are appropriately positioned relative to one another and the form 30 as they begin to move up the form 30.

The first and second belts 42 and 44 include respectively first and second raised portions 42a and 44a, shown only in FIG. 9, which extend longitudinally along inner surfaces of the belts 42 and 44. The raised portions 42a and 44a are received in the recessed portions 45c of the rollers 45a and 45b to maintain the belts 42 and 44 properly positioned relative to the form 30 as the belts 42 and 44 reverse their direction at the bottom end 32e of the cylinder 32 and begin to move up the outer form portion 30b. It is also contemplated that the form 30 may include longitudinally extending recesses (not shown) along its inner and outer portions 30a and 30b for receiving the raised portions 42a and 44a of the belts 42 and 44. It is further contemplated that the belts 42 and 44 may not include raised portions and the rollers 45a and 45b may not have recessed portions.

The conveying apparatus 40 further includes first and second drive rollers 46 and 48, see FIGS. 7 and 7A. The drive apparatus 60, which comprises a conventional DC motor 62 coupled to a gear reducer 64, is coupled to the first drive roller 46 via first and second sprockets 66a and 66b and a chain 66c. The first sprocket 66a is coupled to a shaft 46a of the first drive roller 46 so as to rotate with the roller 46. The second sprocket 66b is coupled to a first output shaft 64a of the gear reducer 64 so as to rotate with the shaft 64a. The drive chain 66c extends about the two sprockets 66aand 66b.

A first gear 46b is coupled to the first drive roller shaft 46a so as to rotate with roller 46. A second gear 48a is coupled to a shaft 48b of the second drive roller 48 so as to rotate with the second roller 48. The first and second gears 46b and 48a intermesh with one another such that rotary movement of the first drive roller 46 effects rotary movement of the second drive roller 48.

First and second spring-loaded idler rollers 47a and 47b are positioned respectively below and above the first drive roller 46, see FIG. 7A. The first belt 42 passes between and is gripped by the first idler roller 47a and the first drive roller 46 and then passes between and is gripped by the second idler roller 47b and the first drive roller 46. The first drive roller 46 is rotated in a direction by the motor 62 such that the belt 42 moves upwardly along the outer portion 30b of the form 30 and returns downwardly through the inner passage 34.

Third and fourth spring-loaded idler rollers 49a and 49b are positioned respectively below and above the second drive roller 48, see FIG. 7A. The second belt 44 passes between and is gripped by the third idler roller 49a and the second drive roller 48 and then passes between and is gripped by the fourth idler roller 49b and the second drive roller 48. The second drive roller 48 is caused to rotate by the first drive roller 46 such that the belt 44 moves upwardly along the outer portion 30b of the form 30 and returns downwardly through the inner passage 34.

The fiber dispensing apparatus 50 comprises first, second, third and fourth generally circular carousels 52, 54, 56 and 58, see FIGS. 1, 1A and 5. Each carousel 52, 54, 56 and 58 is rotatably supported upon a plurality of rigid polymeric rollers 59 (shown in FIG. 1 but not in FIG. 5). The rollers 59 are rotatably mounted via bearings (not shown) to shafts (not shown) fixedly coupled to a main support frame 59a. Each roller 59 has a first portion 59b having a first diameter and a second portion 59c having a second diameter which is greater than the first diameter. The carousels 52, 54, 56 and 58 rest on the roller first portions 59b.

Each carousel 52, 54, 56 and 58 includes an outer peripheral recessed portion 51a, shown in FIG. 2 but not in FIG. 1A, which is adapted to receive an endless drive belt 51b. A plurality of teeth (not shown) are provided in the recessed portion 51a and on an inner portion of the drive belt 51b. The teeth in the recessed portion 51a intermesh with the teeth on the endless drive belt 51b such that rotation of the endless drive belt 51b effects rotation of the carousel.

First and second pulleys 51c and 51d having drive teeth 51e engage the belts 51b to effect rotation of the belts 51b, see FIGS. 1 and 5. The first pulleys 51c drive the belts 51b associated with the first and fourth carousels 52 and 58. The second pulleys 51d drive the belts 51b associated with the second and third carousels 54 and 56. Conventional rotary motion transfer apparatus 53 is coupled between a second output shaft 64b of the gear reducer 64 and the first and second pulleys 51c and 51d to effect rotation of the pulleys 51c and 51d. In the illustrated embodiment, the first pulleys 51c cause the first and fourth carousels 52 and 58 to turn in a counterclockwise direction, see FIGS. 1 and 5, while the second pulleys 51d cause the second and third carousels 54 and 56 to turn in a clockwise direction.

Each of the carousels 52, 54, 56 and 58 includes a centrally located bore 51f through which the form 30 and the belts 42 and 44 extend, see FIG. 5.

In the embodiment illustrated in FIGS. 1 and 2, a plurality of first holding elements 406 are positioned about and coupled to an outer circumferential portion 55 of an upper surface 55a of each of the carousels 52, 54, 56 and 58. The fiber sources 204 are mounted to the holding elements 406 which maintain the fiber sources 204 at an angle of from about 1.0 degree to about 89.9 degrees relative to the upper surface 55a of the carousel. The fiber sources 204 and the holding elements 406 define dispensing stations 407. In the illustrated embodiment, the fiber sources 204 mounted on the first and fourth carousels 52 and 58 form an angle of about 135° with the upper surfaces 55a of the first and fourth carousels 52 and 58. The fiber sources 204 mounted on the second and third carousels 54 and 56 form an angle of about 45° with the second and third carousel upper surfaces 55a. Each carousel 52, 54, 56 and 58 also includes a guide element 57 fixedly mounted thereto having a plurality of guide slots 57a. The slots 57a extend completely through the guide elements 57 and are positioned at an angle, e.g., 45° or 135°, relative to the upper carousel surfaces 55a.

A second holding element 408 is coupled to the upper surface 55a of each of the first, second and third carousels 52, 54 and 56, see FIGS. 1A and 2. An adhesive layer source 502, comprising an adhesive layer 500 wound about a spool 504, is mounted to each of the second holding elements 408. In the illustrated embodiment, the adhesive layer sources 500 are mounted to the carousels 52, 54 and 56 such that they form an angle of about 45° with the upper surface 55a of each carousel 52, 54 and 56. It is also contemplated that the adhesive sources 502 may be mounted to a second holding element 408 coupled to a lower surface of each of the second, third and fourth carousels 54, 56 and 58.

In the illustrated embodiment, the adhesive layers 500 comprise a film or web formed from a thermoplastic material such as a polyamide, polypropylene, polyester, polyethylene, polyphenylene sulfide or like material. The adhesive layer 500 may also comprise a double-sided adhesive tape or a layer of thermosetting material.

The ribbons 200 extending from the spools 202 pass through the guide slots 57a and are wrapped about the belts 42 and 44 and the form 30 as the carousels 52, 54, 56 and 58 are rotated about the form 30. First, second and third adhesive layers 500a-500c extending from the three spools 504 are also wrapped about the belts 42 and 44 and the form 30 as the carousels 52, 54 and 56 are rotated.

The ribbons 200 extending from the first carousel 52 are wrapped about the belts 42 and 44 and the form 30 to form a first material layer 210, see FIGS. 1A and 10. The first adhesive layer 500a extending from the first carousel 52 is wrapped about the first layer 210. The ribbons 200 extending from the second carousel 54 are wrapped about the first adhesive layer 500a and the first material layer 210 to form a second material layer 212. The second adhesive layer 500b extending from the second carousel 54 is wrapped about the second layer 212. The ribbons 200 extending from the third carousel 56 are wrapped about the second adhesive layer 500b and the second material layer 212 to form a third material layer 214. The third adhesive layer 500c extending from the third carousel 56 is wrapped about the third layer 214. The ribbons 200 extending from the fourth carousel 58 are wrapped about the third adhesive layer 500c and the third material layer 214 to form a fourth material layer 216. Thus, the first adhesive layer 500a is positioned between the first and second layers 210 and 212, the second adhesive layer 500b is positioned between the second and third layers 212 and 214 and the third adhesive layer 500c is positioned between the third and fourth layers 214 and 216. Preferably, the width of the first adhesive layer 500a is the same as the combined widths of the ribbons 200 extending the first carousel 52 and the same as the combined widths of the ribbons extending from the second carousel 54; the width of the second adhesive layer 500b is the same as the combined widths of the ribbons extending from the second carousel 54 and the same as the combined widths of the ribbons 200 extending from the third carousel 56; and the width of the third adhesive layer 500c is the same as the combined widths of the ribbons extending from the third carousel and the same as the combined widths of the ribbons 200 extending from the fourth carousel 58. As will be discussed further below, the adhesive layers 500a-500c bond the first, second, third and fourth material layers 210, 212, 214 and 216 to one another to form the fabric 100.

As noted above, the first and fourth carousels 52 and 58 rotate in a counterclockwise direction, while the second and third carousels 54 and 56 rotate in a clockwise direction. Hence, portions 200a of the ribbons 200 extending from the first carousel 52 form with a first horizontal axis A₁ extending across the form 30 an angle θ₁ of from about 1° to about 89.9°; portions 200b of the ribbons 200 extending from the second carousel 54 form with a second horizontal axis A₂ extending across the form 30 an angle θ₂ of from about −1° to about −89.9°; portions 200c of the ribbons 200 extending from the third carousel 56 form with a third horizontal axis A₃ extending across the form 30 an angle θ₃ of from about −1° to about −89.9°; and portions 200d of the ribbons 200 extending from the fourth carousel 58 form with a horizontal axis A₄ extending across the form 30 an angle θ₄ of from about 1° to about 89.9°. In the embodiment illustrated in FIG. 1A, the ribbon portions 200a and 200d from the first and fourth carousels 52 and 58 form an angle of about 45° with the horizontal axes A₁ and A₄ and the ribbon portions 200b and 200c extending from the second and third carousels 54 and 56 form an angle of about −45° with the horizontal axes A₂ and A₃.

As noted above, the width of each adhesive layer 500a-500c should be substantially equal to the combined widths of the ribbons 200 extending from the carousel to which the adhesive layer is mounted and the combined widths of the ribbons 200 extending from the carousel directly above the carousel to which the adhesive layer is mounted. This ensures that generally the entire surface of each of the two material layers on opposite sides of a given adhesive layer is in contact with that adhesive layer. Assuming that the width of the adhesive layer is generally the same as the combined widths of the ribbons extending from the carousel to which it is mounted and the combined widths of the ribbons 200 extending from the carousel directly above the carousel to which the adhesive layer is mounted, and the adhesive layer and the ribbons 200 are rotating about the form 30 at generally the same speed, the angle at which the adhesive layer is applied to the form 30 should be generally equal to the angle at which the ribbons 200 are applied to the form 30.

It is also contemplated by the present invention that the second and third carousels 54 and 56 may rotate in a counterclockwise direction, while the first and fourth carousels 52 and 58 rotate in a clockwise direction. Other carousel rotation direction combinations not explicitly set out herein are possible, including rotating all of the carousels 52, 54, 56 and 58 in the same direction.

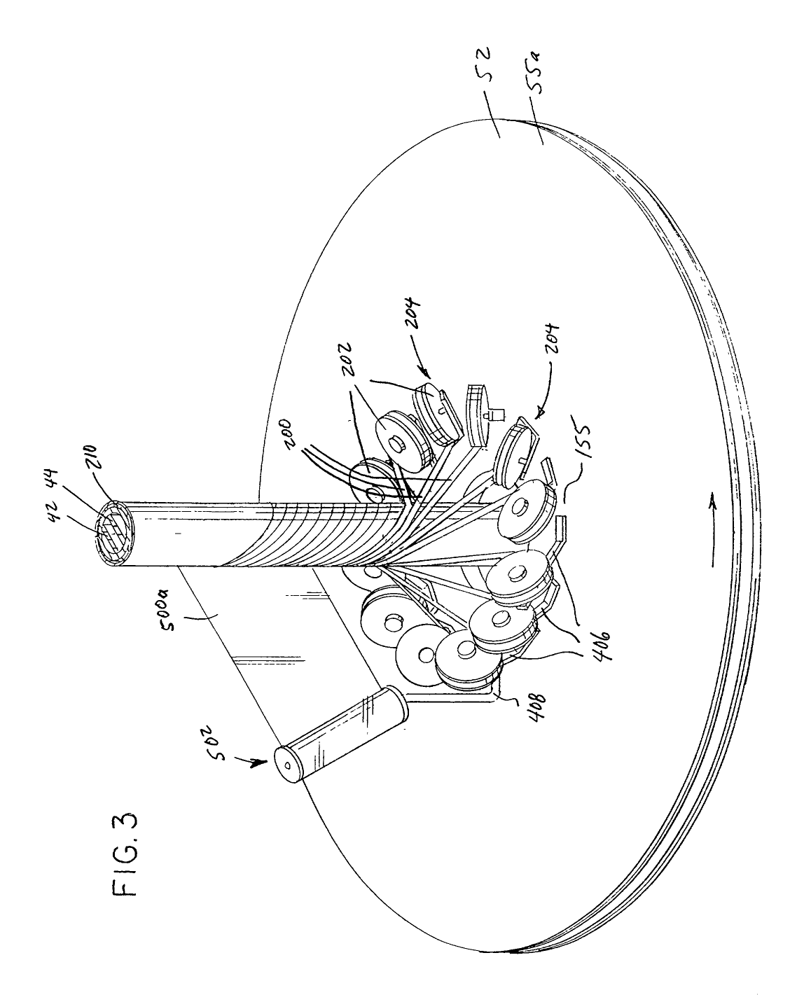

In a first alternative embodiment illustrated in FIG. 3, where like reference numerals indicate like elements, the first and second holding elements 406 and 408 are positioned about and coupled to an inner circumferential portion 155 of the upper surface 55a of each of the carousels 52, 54, 56 and 58. It is preferred that the fiber sources 204 and the adhesive layer sources 502 be mounted as to close to the form 30 as possible as this allows the ribbons 200 and the adhesive layers 500a-500c to be more accurately placed and wrapped about the form 30.

In a second alternative embodiment illustrated in FIG. 4, where like reference numerals indicate like elements, a plurality of ribbon sources 604, four in the illustrated embodiment, are positioned about and coupled to the outer circumferential portion 55 of the upper surface 55a of each of the carousels 52, 54, 56 and 58. A like number of idler guides 605 are positioned about and coupled to the inner circumferential portion 155 of the upper surface 55a of each of the carousels 52, 54, 56 and 58. Each ribbon source 604 comprise a spool 602 and a single, unidirectional ribbon 600 wrapped about the spool 602. The ribbon 600 is formed from one or more combined tows, each having, for example, about 12,000 fibers. The fibers of the tows are separated or spread using the apparatus disclosed in the U.S. patent application previously incorporated herein by reference, entitled [symbol] APPARATUS AND METHOD FOR SPREADING FIBROUS TOWS INTO LINEAR ARRAYS OF GENERALLY UNIFORM DENSITY AND PRODUCTS MADE THEREBY, [symbol] and joined together via a polymeric material to form the ribbon 600. Each ribbon 600 preferably has a width of from about 3 inches to about 12 inches. Before being wrapped about the form 30, the ribbons 600 engage a corresponding idler guide 605 which properly locates the ribbon 600 relative to the form 30.

It is further contemplated that one or more warp beams (not shown), i.e., spools with flanges, each having a plurality of individual fibers or strands of fibers, may be positioned about and coupled to the inner circumferential portion 155 or the outer circumferential portion 55 of the upper surfaces 55a of each of the carousels 52, 54, 56 and 58. Each warp beam may have, for example, from about 10 to about 1000 individual fibers or fiber strands wrapped about it. As noted above, the term [symbol] fiber [symbol] is used herein to describe a single filament. The term [symbol] strand [symbol] is used herein to describe two or more fibers which are bonded or otherwise held together. Such warp beams and fibers or fiber strands are used in place of the single ribbon sources 204 and 604. It is also contemplated that an eyelet guide device (not shown) such as a ring-shaped eyeboard (not shown) having a plurality of eyelets extending completely through the eyeboard and arranged in rows which extend completely around the eyeboard may be coupled to each of the carousels 52, 54, 56 and 58. Preferably, the eyeboards are positioned near and surround the form 30. Any other equivalent fiber or strand guide device may also be used. The fibers and strands of this embodiment may be formed from any one of the materials set out above from which the fibers incorporated into the ribbons 200 are formed.

Referring again to FIG. 1, a combining station 80 is positioned above the fourth carousel 58 and surrounds the form 30, see FIG. 1. A cooling station 90 is positioned above the combining station 80 and is located adjacent to the form 30. The separating station 70 is located over the cooling station 90 and is positioned adjacent to the form 30.

During operation of the apparatus 10, the motor 62 causes the belts 42 and 44 and the carousels 52, 54, 56 and 58 to move continuously. As the carousels 52, 54, 56 and 58 rotate about the form 30, the ribbons 200 and the adhesive layers 500a-500c are wrapped about the form 30 and are moved by the belts 42 and 44 upwardly along the form 30. The wrapped ribbons 200 and the adhesive layers 500a-500c move through the combining station 80 and the cooling station 90 where they are combined to form a fabric 100. From the cooling station, the fabric 100 is moved by the belts 42 and 44 to the separating station 70 where the fabric 100 is slit to permit it to be removed from the form 30 as will be discussed further below.

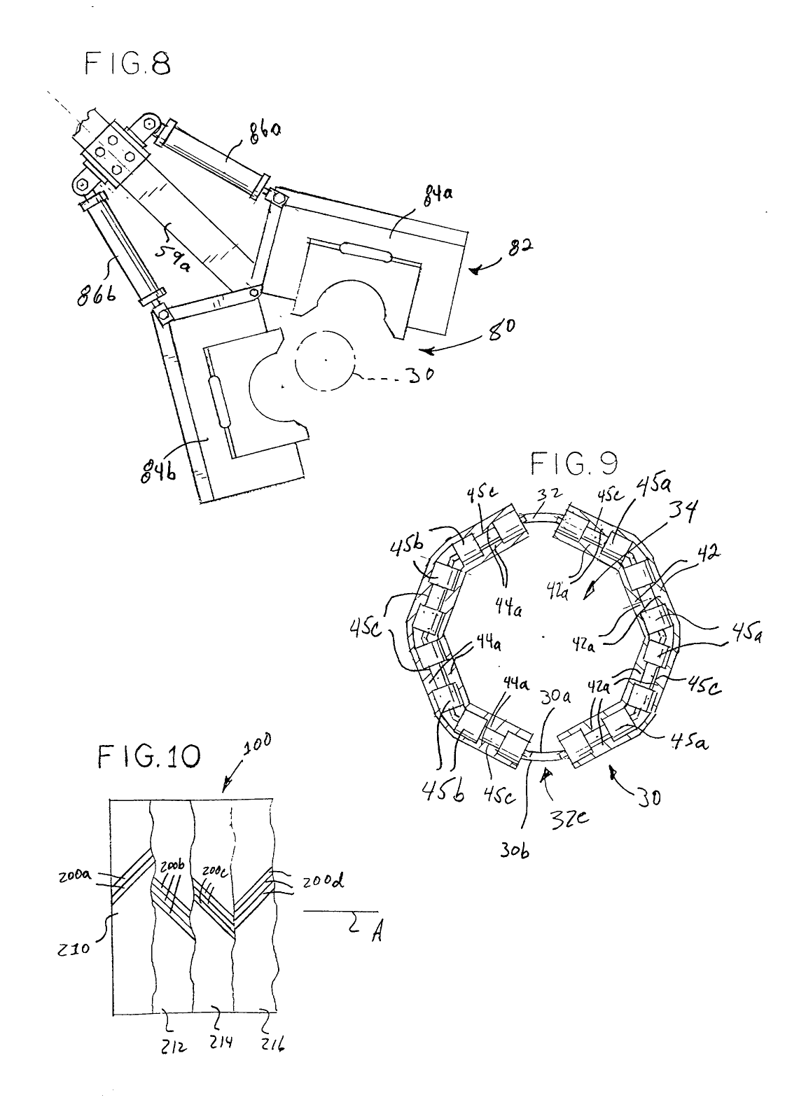

The combining station 80 in the illustrated embodiment comprises a radiant heater 82 which is coupled to the frame 59a, see FIG. 8. The heater 82 includes first and second sections 84a and 84b which are pivotable toward and away from one another via first and second piston/cylinder units 86a and 86b. Prior to operation of the apparatus 10, the sections 84a and 84b are pivoted to their closed positions such that they encase the form 30. Upon receiving power, the heater 82 radiantly heats the first, second, third and fourth material layers and the first, second and third adhesive layers 500a-500c. As noted above, the adhesive layers 500a-500c comprise, in the illustrated embodiment, thermoplastic webs or films. The heat energy generated by the heater 82 causes the polymeric material of the layers 500a-500c to sufficiently soften or melt such that it flows into and between the fibers of the layers 210, 212, 214 and 216.

The cooling station comprises a conduit 92 which is coupled to a fan or an air cooling apparatus (not shown). An end portion 92a of the conduit is positioned adjacent to the form 30 just above the combining station 80. The cooled air emitted from the end portion 92a accelerates the solidification or hardening of the heated polymeric material between the layers 210, 212, 214 and 216. Upon solidifying, the polymeric material bonds or fuses the layers 210, 212, 214 and 216 to one another to form the fabric 100.

In the embodiment illustrated in FIG. 10, the ribbon portions 200a and 200d of the first and fourth layers 210 and 216 extend at an angle of about 45 degrees relative to a horizontal axis A and the ribbon portions 200b and 200c of the second and third layers 212 and 214 extend at an angle of about −45 degrees relative to the horizontal axis A. The ribbon portions 200a and 200d may extend at an angle of from about 1.0 degree to about 89.9 degrees relative to the horizontal axis A and the ribbon portions 200b and 200c may extend at an angle of from about −1.0 degree to about −89.9 degrees relative to the horizontal axis A.

The separating station 70 comprises a conventional pneumatic cutter 74 having a diamond cut-off wheel 74a. The cutter 74 creates a single slit 100a in the fabric 100. After being cut, the fabric 100 is pulled over a roller 75 via a conventional wind up device (not shown) or other pulling device, see FIG. 1. The fabric 100, after being cut, opens or expands from its cylindrical shape to a generally planar shape. It is further contemplated that two or more slits could be made in the fabric 100.

It is also contemplated that a fabric 100 could be formed from composite material strands such as the commingled reinforcing and polymer fiber strands disclosed in U.S. Pat. No. 5,626,643, entitled “METHOD AND APPARATUS FOR FORMING COMPOSITE STRANDS,” the disclosure of which is incorporated herein by reference. The reinforcing fibers used in the commingled strands may comprise glass fibers, natural fibers or other synthetic fibers, such as those discussed above which are incorporated into the ribbons 200. The polymer fibers may be selected from the group consisting of polyamide fibers, polypropylene fibers, polyester fibers, polyethylene fibers and polyphenylene sulfide fibers. The polymer fibers may also comprise fibers formed from any other fiberizable polymer material. It is also contemplated that the composite material strands may comprise reinforcing fibers having a polymeric material coated thereon or reinforcing and polymeric matrix fibers having a polymeric material coated thereon such as those disclosed in copending U.S. patent application Ser. No. 08/695,909, filed on Aug. 12, 1996, and entitled “CHEMICAL TREATMENTS FOR FIBERS AND WIRE-COATED COMPOSITE STRANDS FOR MOLDING FIBER-REINFORCED THERMOPLASTIC COMPOSITE ARTICLES,” by Andrew B. Woodside, and in copending U.S. patent application Ser. No. 08/695,504, filed on Aug. 12, 1996, and entitled “CHEMICAL TREATMENTS FOR FIBERS AND WIRE-COATED COMPOSITE STRANDS FOR MOLDING FIBER-REINFORCED THERMOPLASTIC COMPOSITE ARTICLES,” by Andrew B. Woodside, the disclosures of which are incorporated herein by reference.

The polymeric material incorporated into the composite strands provides the bonding mechanism for the fabric formed from those composite strands. Thus, as the strands pass through the combining station 80, the polymeric material incorporated into the composite strands sufficiently softens or melts such that adjacent strand portions bond or fuse to one another at points where the adjacent strand portions cross one another. The bonded strand portions form the fabric. It is also contemplated that one or more polymeric material film or web layers may be combined with the composite strands in forming a fabric.

In the illustrated embodiment, the speed of each of the carousels 52, 54, 56 and 58 is fixed relative to the speed of the belts 42 and 44 via the gearing arrangement provided. The angles at which the ribbons 200 and the layers 500a-500c are applied to the form 30 can be varied by changing the ratio of the speed of the carousels 52, 54, 56 and 58 to the speed of the belts 42 and 44. This can be achieved by substituting a different gearing arrangement for the one provided. It is also contemplated that a first drive motor may be provided for the belts 42 and 44 and a second drive motor may be provided for the carousels 52, 54, 56 and 58. The first and second drive motors may comprise conventional speed control motors, stepper motors or servo-motors, such that the speed ratio can be changed via the processor controlling those motors. A separate speed control motor, servo-motor or stepper motor may be provided for each of the carousels 52, 54, 56 and 58 to permit the speed of each of the carousels 52, 54, 56 and 58 to be controlled independently of the other carousels.

The weight of the fabric 100 can be changed by varying the number of ribbons 200 used and/or changing the weight and/or width of the ribbons 200. To vary the spacing between the ribbons 200 in the fabric 100, the angles at which the ribbons 200 are wrapped about the form 30 are varied and/or the number of ribbons 200 provided is changed.

It is further contemplated that ribbons 200, individual single material fibers, single material fiber strands or composite material strands may be provided which are located in the machine direction, designated by arrow 300 in FIG. 1A, which direction is generally parallel to a longitudinal axis of the form 30. The term [symbol] individual single material fiber [symbol] is used herein to describe a discrete fiber formed from any one of the materials set out above from which the fibers incorporated into the ribbons 200 are formed. The term [symbol] single material fiber strand [symbol] is used herein to describe two or more fibers made from any one of the materials set out above from which the fibers incorporated into the ribbons 200 are formed. It is also contemplated that polymer strands, webs or films formed from a polymeric material such as any one of the materials set out above from which the adhesive layers 500a-500c are formed could run in the machine direction 300 and could be used in place of or in addition to the adhesive layers 500a-500c. It is additionally contemplated that commingled or mixed reinforcing and polymer fiber strands or reinforcing fibers coated with a polymeric material could be positioned in the machine direction 300 and used in place of or in addition to the adhesive layers 500a-500c. It is still further contemplated that polymeric web or film material, polymer fibers, commingled or mixed reinforcing and polymer fiber strands and/or polymer coated reinforcing fibers having polymeric material with a melting temperature below the melting temperature of the polymeric material incorporated into composite strands wrapped about the form 30 could be provided such that they run in the machine direction 300. As such, the polymeric material of the web or film material, polymer fibers, commingled reinforcing and polymer fiber strands and/or polymer coated reinforcing strands would soften or melt in the combining station 80 to bond together the wrapped composite strands without the polymeric material of the wrapped composite strands melting.

It is further contemplated that three or more belts may be provided instead of just the two belts 42 and 44 included in the illustrated embodiments. It is also contemplated that when the form 30 is solid, each of the belts 42 and 44 moves along an endless path which is defined by idler rollers spaced away from the form 30. It is still further contemplated that the carousels may be replaced by carts or other fiber, strand or ribbon carriers which travel about the form 30 such as along rails.

It is still further contemplated that one or more release layers (not shown) may be provided between two or more of the material layers 210, 212, 214 and 216 to permit two or more separate fabrics to be formed simultaneously on the form 30.

Having described the invention in detail and by reference to preferred embodiments thereof, it will be apparent that modifications and variations are possible without departing from the scope of the invention defined in the appended claims.

What is claimed is:

1. An apparatus for making a fabric from one or more fibers comprising:
a generally cylindrical form about which one or more fibers are wrapped;
conveying apparatus including at least one conveyor element traveling along said form and also about which said one or more fibers are wrapped for moving said wrapped fibers along said form;
fiber dispensing apparatus movable about said form;
drive apparatus coupled to said conveying apparatus and said fiber dispensing apparatus for effecting movement of said at least one conveyor element and said fiber dispensing apparatus;
said fiber dispensing apparatus supporting one or more fiber sources such that said one or more fiber sources are movable with said dispensing apparatus around said form thereby allowing said one or more fibers from said one or more fiber sources to be wrapped about said form and said at least one conveyor element as said dispensing apparatus moves around said form; and
separating apparatus positioned at a separating station for separating said fabric from one or both of said form and said at least one conveyor element.

2. An apparatus as set forth in claim 1, wherein said form comprises a circular cylinder having an inner passage.

3. An apparatus as set forth in claim 2, wherein said at least one conveyor element comprises first and second conveyor elements.

4. An apparatus as set forth in claim 3, wherein said first and second conveyor elements comprise first and second endless belts.

5. An apparatus as set forth in claim 4, wherein said conveying apparatus further comprises drive rollers coupled to said drive apparatus and a plurality of idler rollers which together along with inner and outer sections of said cylinder define paths about which said endless belts travel.

6. An apparatus as set forth in claim 4, wherein said first and second endless belts extend through said inner passage of said cylinder.

7. An apparatus as set forth in claim 1, further including a combining station positioned in proximity of an end section of said form, said fibers being joined to one another at said combining station to form said fabric.

8. An apparatus as set forth in claim 7, wherein said combining station comprises one of a radiant heater, a convection oven and an ultra-violet radiation source.

9. An apparatus as set forth in claim 1, wherein said fiber dispensing apparatus comprises a carousel rotatably mounted to a fixed structure, said carousel including a plurality of dispensing stations for supporting said one or more fiber sources.

10. An apparatus as set forth in claim 1, wherein said fiber dispensing apparatus comprises first, second, third and fourth carousels rotatably mounted to a fixed structure and spaced apart from one another, each of said first, second, third and fourth carousels including a plurality of dispensing stations for supporting a plurality of said fiber sources.

11. An apparatus as set forth in claim 1, wherein said drive apparatus comprises a first drive motor coupled to said conveying apparatus for effecting movement of said at least one conveyor element and a second drive motor coupled to said fiber dispensing apparatus for effecting movement of said fiber dispensing apparatus.

12. An apparatus for making a fabric from one or more fibers comprising:
a generally hollow form about which one or more fibers are wrapped;
conveying apparatus including at least one conveyor element traveling along said form and also about which said one or more fibers are wrapped for moving said wrapped fibers along said form;
fiber dispensing apparatus movable about said form;
drive apparatus coupled to said conveying apparatus for effecting movement of said at least one conveyor element;
said fiber dispensing apparatus supporting one or more fiber sources such that said one or more fiber sources are movable with said dispensing apparatus around said form thereby allowing said one or more fibers from said one or more fiber sources to be wrapped about said form and said at least one conveyor element as said dispensing apparatus moves around said form; and
separating apparatus positioned at said separating station for cutting said fabric.

13. An apparatus as set forth in claim 12, wherein said hollow form comprises a circular cylinder having an inner passage.

14. An apparatus as set forth in claim 13, wherein said at least one conveyor element extends through said inner passage of said cylinder.

15. A method for forming a fabric from a plurality of fibers comprising the steps of:
providing one or more fibers;
providing a non-planar form and at least one conveyor element which is adapted to move along said form;
wrapping said one or more fibers about said form and said at least one conveyor element for forming a fabric;
moving said at least one conveyor element along said form such that said wrapped one or more fibers are moved along said form;
separating said fabric from one or both of said at least one conveyor element and said form.

16. A method as set forth in claim 15, wherein said step of wrapping one or more fibers about said form and said at least one conveyor element comprises the steps of:
providing a fiber dispensing apparatus movable around said form for supporting said one or more fibers such that said fibers are movable with said dispensing apparatus; and
moving said fiber dispensing apparatus around said form such that said one or more fibers are wrapped about said form and said at least one conveyor element.

17. A method as set forth in claim 15, wherein said step of providing a non-planar form comprises the step of providing a circular cylinder having an inner passage.

18. A method as set forth in claim 17, wherein said one or more fibers are wrapped about said cylinder such that portions of said one or more fibers form with an axis extending across said cylinder an angle of from about 1° to about 89.9°.

19. A method as set forth in claim 15, wherein said step of providing one or more fibers comprises the steps of providing a plurality of fibers of composite material.

20. A method as set forth in claim 15, wherein said step of providing one or more fibers comprises the step of providing one or more ribbons each of which is formed from a plurality of reinforcing fibers.

21. A method as set forth in claim 15, wherein said step of providing one or more fibers comprises the step of providing a plurality of carbon fibers.

22. A method as set forth in claim 21, wherein said carbon fibers are joined together by a polymeric material.

23. A method as set forth in claim 15, wherein said step of providing one or more fibers comprises the step of providing one or more fibers selected from the group consisting of S-glass fibers, E-glass fibers, graphite fibers, aramid fibers, polyimide fibers, cotton fibers, polyester fibers, and silicon carbide fibers.

24. A process for forming a carbon fiber fabric comprising the steps of:
providing one or more carbon fibers;
wrapping said one or more carbon fibers about a non-planar form; and
joining portions of said one or more fibers to one another.

25. A process as set forth in claim 24, wherein said step of providing one or more carbon fibers comprises the step of providing first and second ribbons of carbon material each including a plurality of carbon fibers which are joined to one another via a polymeric material.

26. A process as set forth in claim 25, wherein said wrapping step comprises the steps of:
wrapping said first ribbon about said form such that portions of said first ribbon form with an axis extending across said form an angle of from about 1° to about 89.9°; and
wrapping said second ribbon about said form such that portions of said second ribbon form with said axis an angle of from about −1° to about −89.9°.

27. A process as set forth in claim 24, wherein said joining step takes place without a weaving or knitting step being performed.

28. A fabric comprising:
one or more spread fiber tows wherein first portions of said one or more tows are angularly positioned relative to second portions of said one or more tows and are joined to said first portions.

29. A fabric as set forth in claim 28, wherein each of said one or more spread fiber tows comprises a plurality of fibers spread from a first areal density to a second, lighter areal density.

30. A fabric as set forth in claim 28, wherein said one or more spread fiber tows comprise one or more ribbons having a plurality of spread fibers.

31. A fabric as set forth in claim 30, wherein said fibers comprise carbon fibers.

32. A fabric as set forth in claim 30, wherein said ribbons further include polymeric material for maintaining said fibers in a spread condition.

33. A fabric as set forth in claim 28, wherein said first tow portions form with a first horizontal axis an angle of from about 1.0 degree to about 89.9 degrees and said second tow portions form with a second horizontal axis an angle of from about −1.0 degree to about −89.9 degrees.

34. A process for forming a fabric comprising the steps of:
providing one or more spread tows;
wrapping said one or more tows about a form;
joining first portions of said one or more tows to second portions of said one or more tows.

35. A process for forming a fabric as set out in claim 34, wherein said wrapping step comprises the step of wrapping said one or more tows about a cylindrical form.

36. A process for forming a fabric as set forth in claim 34, wherein said step of providing one or more spread tows comprises the step of providing one or more ribbons formed from one or more spread tows.
